(19) United States
(12) Patent Application Publication
(10) Pub. No.: US 2002/0070633 A1
(43) Pub. Date: Jun. 13, 2002

(54) Electrical power generator

(76) Inventors: Warren Emil Salender, San Diego, CA (US); Gabriel Hons-Olivier, San Diego, CA (US)

Correspondence Address: Thomas J. Tighe, Esq., 6265 Greenwich Drive, Suite 103, San Diego, CA, 92122, US

(21) Appl. No.: 09/735,001

(22) Filed: Dec. 12, 2000

(51) Int. Cl. B60L 1/02

(52) U.S. Cl. 310/306

(57) ABSTRACT

Heat generated by a fuel burning lantern is conducted to one operative surface of a solid state, thermoelectric converter. A heat sink, in contact with the module's other operative surface dissipates heat from the other surface creating a temperature differential between the two surfaces. In response to this differential, the thermoelectric converter generates direct current which can be used to energize a small radio or other small electric devices or appliances. Also, conventional lanterns can be retrofitted with a converter, according to this invention.

### BACKGROUND OF THE INVENTION

This invention relates in general to the field of electrical power generation by a temperature differential, and more particularly to an apparatus for providing a reliable and portable source of inexpensive current capable of powering small electric devices and appliances.

In some rural areas and even in some urban areas of less developed countries, there are no power lines to provided electrical power. In such unpowered areas, small electrical appliances, e.g. radios, must be powered by battery or a fuel burning generator. Generally such generators must be transported by a vehicle due to weight. Also, they are noisy, consume large amounts of fuel, and cannot always be moved to where people may need them. Batteries run down and may not be available when needed.

Nevertheless, people in these un-powered areas need to keep themselves abreast of weather and other events which could affect them, and they also desire access to information and world events, all of which are available by radio. It is estimated that over fifty percent of the world's population is without electricity. Thus, there is a need for an inexpensive, reliable, portable source of power to energize small appliances, e.g. radios.

The above-mentioned problems are addressed and solved by a novel hand-carried, heat-producing lantern which can, according to this invention, provide enough direct current (DC) power to operate a radio or other small appliance. A lantern according to this invention not only provides light but can also function as a DC generator. The lantern can be easily transported anywhere, operates silently and, unlike solar cells, can be operated at night. Optionally an inverter, or other DC to AC (alternating current) converter, can be included in this invention to power AC appliances.

It is also advantageous to have a light-weight, small electrical power source when camping in places with no electrical outlets, especially if the power source is combined with a lantern to provide light as well as electricity.

Other advantages and attributes of this invention will be readily discernable upon a reading of the text hereinafter.

### SUMMARY OF THE INVENTION

An object of this invention is to provide a hand-transportable apparatus for generating direct current (DC) electrical power by means of a temperature differential.

A further object of this invention is to provide an apparatus for generating electrical power, the apparatus including a hand-transportable heat source communicating heat to a thermoelectric converter, the heat creating a temperature differential in the converter, the converter producing DC power in response to the differential.

A further object of this invention is to provide an apparatus as described in the immediately preceding paragraph, the heat source heating one element of the thermoelectric converter, and including a heat sink for cooling another element of the converter, the converter producing DC power in response to the temperature differential between the two elements.

A further object of this invention is to provide an apparatus as described in the preceding paragraphs wherein the heat source is a hand-portable lantern.

A further object of this invention is to provide an apparatus as described in the preceding paragraph which uses a chimney-like channel to communicate heat from the lantern to the thermoelectric converter.

A further object of this invention is to provide an apparatus as described in the preceding paragraphs wherein the lantern is a portable kerosene fueled lantern.

A further object of this invention is to provide an apparatus as described in the preceding paragraphs wherein the lantern is a portable propane fueled lantern.

A further object of this invention is to provide an apparatus as described in the preceding paragraphs which uses a heat conductor to transport heat from the lantern to the thermoelectric converter.

A further object of this invention is to provide an apparatus as described above which comprises a conventional heat-producing lantern retrofitted with a thermoelectric converter according to this invention.

These objects, and other objects expressed or implied in this document, are accomplished by a hand-portable heat source, preferably a fuel burning lantern, produces heat which is conducted to one operative surface of a solid state, thermoelectric converter affixed to the heat source. A heat sink, in contact with the module's other operative surface dissipates heat from the other surface creating a temperature differential between the two surfaces. In response to this differential, the thermoelectric converter generates direct current which can be used to energize a small radio or other small electric devices or appliances. Conventional lanterns can be retrofitted with a converter, according to this invention. The thermoelectric modules are formed of numerous semiconductor thermocouples, electrically connected in series and sandwiched between two metalized, ceramic plates, forming a thin, layered block. The module operates on the Peltier effect which causes a temperature change when current passes through the junction of two dissimilar conductors. Passing a direct current through the module causes heat to move from one plate to the other, creating a cold plate and a hot plate. In this manner the thermoelectric module acts as a heat pump. However, a direct current can be generated by the module by heating one plate and cooling the other plate. The temperature differential causes a direct current to flow from one plate to the other, thereby acting as a direct current power source. By adapting a lantern to provide a heat source for one plate of a thermoelectric module and using a heat sink to keep the other plate cool, a direct current is generated by the thermoelectric module due to the temperature differential between its two plates.

### BRIEF DESCRIPTION OF THE DRAWINGS

FIG. 1 is a pictorial view of a fully assembled first embodiment of this invention using a kerosene fueled, portable lantern as a heat source.

FIG. 2 is an elevational view of the bottom of a converter assembly before it is affixed to the top of a lantern of FIG. 1.

FIG. 3 is an elevation view of the converter assembly of FIG. 2, illustrating a heat chimney and heat sink in relation to the lantern top.

FIG. 4 is a pictorial view of a fully assembled second embodiment of this invention using a propane fueled, portable lantern as a heat source.

FIG. 5 is an elevational view of the bottom of a second embodiment converter assembly before it is affixed to the top of a lantern of FIG. 4.

FIG. 6 is an elevation view of the converter assembly of FIG. 4, illustrating how the assembly is affixed to the top of the lantern of FIG. 4 by means of a heat transfer angled coupling plate.

FIG. 7 is an exploded pictorial view of the converter assembly of the lantern of FIG. 1.

FIG. 8 is an exploded pictorial view of the converter assembly of the lantern of FIG. 4.

FIG. 9 is a pictorial partial view of a conventional lantern.

FIG. 10 is an exploded pictorial view of a third embodiment of a thermoelectric converter assembly according to this invention.

FIG. 11 is a plan view of the assembly of FIG. 10.

### DESCRIPTION OF THE PREFERRED EMBODIMENT

Referring to FIG. 1, a first embodiment of this invention, generally designated 2, has a fuel burning lantern 4 as a base and heat source, preferably fueled by kerosene or an equivalent fuel which is contained in a tank 6 at the base of the lantern. A lower end of a wick (not shown) is immersed in the fuel in the tank and the upper end extends centrally into a protected (e.g. against wind and rain) chamber defined by transparent bulbous glass globe 8. By capillary action the wick communicates fuel to its upper end which in operation is lighted to create a flame 10 which illuminates the surrounding area through the globe. Heat rising and escaping from the globe is collected by an open-top, annular heat shroud 12 which funnels the heat upward toward a converter assembly, generally designated 16, which is fastened to the top of the shroud by means of a plurality of spaced radial flanges 14.

As used herein, the terms “upper,” “upward,” “above,” “top,” “lower,” “downward,” “below,” and “bottom” are arbitrarily selected directional references with “upper,” “upward,” “above” and “top” referring to the general gravitational upward direction with respect to the lantern, and “lower,” “downward,” “below” and “bottom” referring to the opposite direction.

Referring to FIGS. 1 and 9, preferably the embodiment of FIG. 1 includes a modified conventional kerosene lantern which before modification has a circular convex hood 17 spaced above the open top of the shroud 12. The hood, which acts as a rain shield and protective cover, also deflects radially the rising heat through annular openings 19 defined by the plurality of tongues 14 which before modification project upwardly from the top of the shroud. Typically the tips of the tongues 14 extend through corresponding slits (not shown) in the hood, and the tips are bent to keep the hood affixed to the tongues. (A lantern such as the “Little Wizard” model from Dietz, Inc. is commercially available and is typical of such lanterns.) Modification, i.e. retro-fitting, is done by straightening the tongues so that they can be removed from the slits, and then removing the hood 17, or if the hood is more permanently attached to the tongues, by cutting the tongues proximate the hood. The tongues 14 are then folded down into radial flanges (as best illustrated in FIG. 1) to which the converter assembly is clamped, e.g. by bolts.

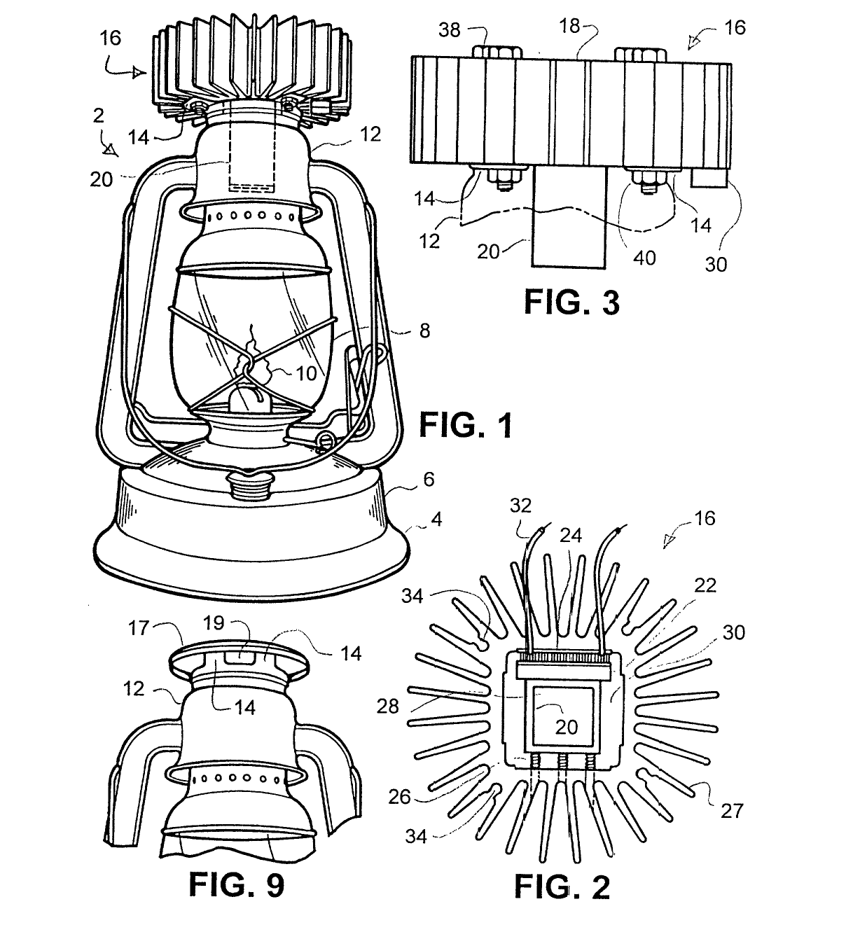

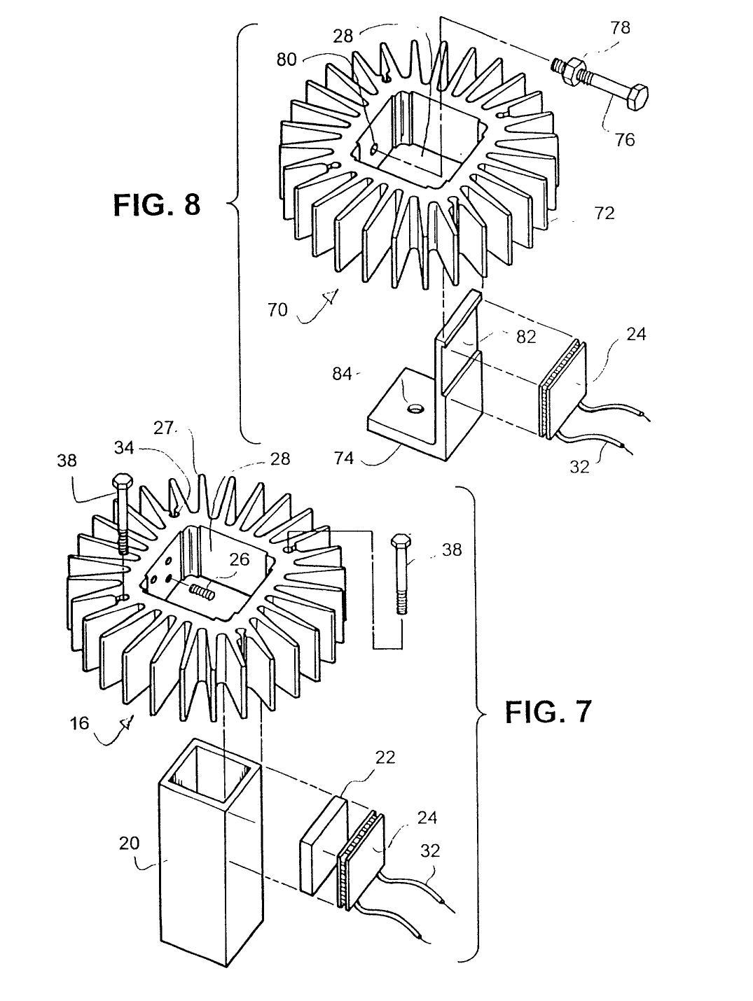

Referring to FIGS. 2 and 7, the first embodiment converter assembly 16 includes a heat sink 18, a chimney-like heat pipe 20, a heat conductor 22, a thermoelectric module 24, and set screws 26. The heat sink 18 as illustrated is preferably a plurality of uniformly angularly spaced heat dissipation fins 27 radiating outward from a center point, and defined around the center point is a square through channel 28. The heat sink is preferably aluminum, which is lightweight and is an excellent heat conductor, but other heat conducting materials could also be used. While the heat sink will effectively operate with a different number and arrangement of fins than illustrated, it preferably has twenty-eight fins uniformly disposed around its perimeter. The through-channel 28 is preferably approximately 2 inches, wall to wall, and the perimeter of the heat sink is preferably approximately 5.3 inches in diameter. The longitudinal dimension, i.e. depth, of the though-channel 28 is at least the equal to the corresponding dimension of the thermoelectric module 24 to achieve maximum contact area between the two for maximum heat transfer from the module to the heat sink. Preferably laterally centered set screws engaged in threaded though-holes defined in a wall of the through-channel 28 clamp the chimney 20 against the heat conductor 22 and hold the thermoelectric module 24 closely against the cavity's wall opposite the threaded holes.

As most clearly illustrated in FIG. 2, in the First preferred embodiment the properly adjusted set screws 26 press against the chimney 20 forcing it against the heat transfer plate 22 which is consequently forced against the module 24 which is consequently forced against the through-channel 28 wall opposite the set screws. Preferably the force against the module 24 also holds it in place. Except for the chimney side pressing against the conductor plate 22 there is a significant air gap 30 between the chimney sides and the heat sink 18. The air gap serves to inhibit heat transfer from the chimney to the heat sink. Although the set screws provide paths of heat conduction, their small diameters minimize heat transfer.

Although set screws are illustrated, other means can be used to press the chimney against the heat transfer plate 22, and press the module 24 against the hint sink without departing from the scope of this invention. For example, a second embodiment as described below illustrates an alternative approach. Also conventional heat conductive adhesives or bonding agents can be used to create heat transfer interfaces between the chimney and plate, and between the module and heat sink.

Referring again to FIGS. 2 and 7, the thermoelectric converter module 24 is preferably a solid state device which generates a direct current electric potential when a temperature differential exists between its two faces, i.e. its two opposite flat surfaces. Such thermoelectric modules are commercially available, e.g. Model HT3-12-30 from Melcor is one satisfactory device for the purposes of this invention. The heat conductor 22 is preferably an aluminum block, or any other rigid material with comparable heat conduction properties, and its thickness is a trade-off. It should be thin enough to allow maximum heat conduction though it, but is preferably thick enough to effectively center the chimney 20 in the through-channel 28 in order to position the chimney to maximally receive heat from the lantern. Preferably the heat conductor is one-quarter inch thick.

Referring again to FIGS. 2, 3 and 7, the chimney 20 is preferably a thin-walled, hollow square tube which is preferably three and one-half inches long. This is sufficient to allow the chimney to extend from the heat sink 18 down into the shroud 12 to receive heat being funnel upward by the shroud. The chimney is preferably a section of an aluminum extrusion, having at least one flat side to abut a flat surface of the heat conductor 22, the chimney flat side preferably being at least as wide as the heat conductor. Preferably the chimney is generally centered in and aligned with the through-channel 28. Also preferably, at least one of the walls of the through-channel 28 has a centered flat recess in which the module is seated. The recess is just slightly wider than the thermoelectric module's width, guiding the module to be properly positioned against the center of the wall and keeping it aligned vertically. Preferably there are recesses in more than one wall of the channel 28, recesses having different widths to accommodate modules of different sizes.

Referring again to FIG. 2, preferably the chimney's top edge is flush with the top edge of the heat conductor and the heat sink. Also, the thermoelectric module can be oriented so that its current carrying wires 32 extend beneath the heat sink 18, as shown in FIG. 2, or they can extend over it as preferred by the user. Since the current generated by the apparatus will normally be powering a small radio or other small electric device, the wires will preferably pass under the heat sink, making a shorter path to the device, which would preferably be placed near the lantern. Preferably the wires 32 are connected to socket or jack 30 affixed to the assembly 16 for quick connect/disconnect of an appliance.

Referring to FIGS. 1-3 and 7, preferably the heat sink 18 has four diagonally spaced, vertical bolt channels 34 defined in the web between adjacent fins 27. To attach the assembly to the shroud 12 of a lantern, bolts 38 are inserted through the channels 34 and are mated with respective nuts 40 to affix to a respective flange 14. This can be done by locating the bolts immediately adjacent to their respective flanges and tightening the nuts so that an edge of each flange is lodged between a respective nut and the heat sink. Washers (not shown) can also be used to increase the area of the tongues secured by the hardware. The flanges 14 can also be modified by drilling a hole or forming a slot in each, through which respective bolts 38 can be inserted and mated with nuts 40 to secure the heat sink 18 to the tongues.

In operation, the converter will begin generating power very shortly after a flame is started in the lantern. To energize a radio, or any other small electrical appliance compatible with DC power, a user simply connects it's power cord to the jack. The invention's module wires can also be terminated in a DC adapter (not shown) which can be plugged into a radio or other small electrical device or appliance equipped to connect with such a DC adapter. The flame generates heat which traverses up the chimney making the walls of the chimney hot. The heated chimney wall abutting the heat transfer plate communicates heat through the plate to one face of the thermoelectric module. The heat sink keeps the opposite face of the thermoelectric module much cooler than the one face. The differential in temperature between the module's opposite faces causes it to produce DC electrical power which is communicated to the jack or adapter. A radio or other appliance plugged into the jack or adapter is thereby energized for operation.

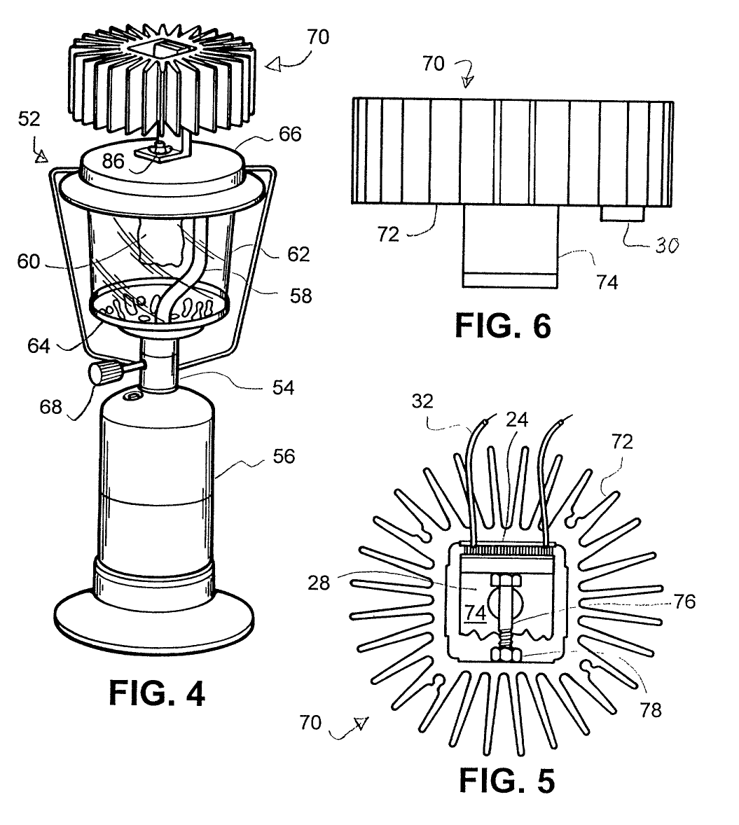

Referring to FIG. 4, a second embodiment of this, generally designated 52, includes a fuel burning lantern 54 fueled by propane or an equivalent gaseous fuel which is contained in a tank 56 at the base of the lantern. The lantern can be, but not necessarily is, a conventional propane lantern modified according to this invention. Pressurized fuel gas from the tank travels through a conduit 58 and is discharged downward into a mantle 60 which in operation is ignited. The fuel burns at and around the mantle's surface where the fuel meets oxygen in the air. The mantle and conduit are disposed in a chamber defined by: (1) a generally cylindrical, open-top, glass shell 62; (2) a shallow, generally cone-shaped, shell support 64; and (3) a cover 66 which closes the top of the shell to keep wind and rain out of the chamber. A plurality of air holes defined in the shell support allow oxygen to reach the flame on the mantle. The amount of fuel supplied to the mantle, and therefore the size of the flame, is controlled by a valve (not shown) disposed in the fuel communication path between the tank 56 and the conduit 58. The valve is controlled by a rotatable knob 68. In the case of a modified conventional lantern, a novel thermoelectric converter assembly, generally designated 70, is affixed to the top cover of the lantern preferably by use of a preexisting wing nut 86 on a threaded stud conventionally used to tighten the top cover 66 onto a conventional bracket (not shown) affixed to the top of the fuel conduit 58. In the case of a novel integral lantern, a top cover is affixed in any manner to close the top of the shell and to accommodate attachment thereto of a heat transfer bracket to communicate heat from the mantel to a converter assembly according to this invention.

Referring to FIGS. 4-6 and 8, the converter assembly 70 includes a heat sink 72 with a centrally disposed through-channel 28, a mounting bracket 74 which also serves as a heat conductor, a thermoelectric module 24, and a press mechanism which is preferably a screw 76 and a mating nut 78. Basically the heat sink 72 is the same as the heat sink 18 of the first embodiment, except the former has only one threaded hole 80 defined centrally in a wall of the channel 28. The mounting bracket 74 is a generally “L” shaped bracket for supporting the heat sink. The bracket also serves to conduct heat from the top cover, heated by the flame, to the thermoelectric module 24. The module is positioned in a shallow recess 82 is defined in the upper portion of the long leg of the bracket. The recess is not as thick as the module but serves to position and support the module. Since the recess is shallow, there is no interference with the wires 32 extending from the bottom of the module 24 when the module is in the recess. The nut 78 is threaded onto the screw 76, which is threaded into hole 80 in a wall of the channel 28 of the heat sink. The bracket, with converter module in the recess, is placed in the through-channel of the heat sink with the module's other face abutting a wall of the channel. The bracket and module are clamped against an inner wall of the heat sink by force applied by screw 76. During assembly, the screw 76 can be unthreaded in the hole 80 until the screw's head abuts the bracket, holding the bracket against the module which is also being held against the heat sink. The screw is then adjusted to hold the bracket, module and heat sink in their juxtaposed position. The nut 78 can be tightened against the wall of the channel to secure the screw in place. The converter module is thus clamped in place with one face against the bracket to receive heat from the lantern and the other face against the heat sink to be cooled. The thermoelectric module can be oriented so that its current carrying wires 32 extend beneath the heat sink 72, as shown in FIG. 8. The current generating assembly 70 is affixed to the top cover 66 by inserting the top cover securing stud (not shown), used to secure the top cover to the conduit 58, through a hole 84 defined in the short leg of the heat conductor 74 and tightening the wing nut 86 on the stud.

Referring to FIGS. 4 and 5, once the mantle 60 has been lighted in the lantern 54, all that needs to be done to operate a radio (not shown), or other small electric appliance, is to connect it to the wires 32 coming from the thermoelectric module 24. Preferably the wire terminate in a jack 30 or other socket compatible with the appliances power cord. Also, the wires can be terminated in a DC adapter (not shown) which can be plugged into a radio or other small electrical device or appliance equipped to connect with such a DC adapter. The flame on the lighted mantle generates heat which rises to heat the top cover 66. This heat is conducted to the heat conductor 74 affixed to the top cover. The heat is conducted through the bracket to one flat surface of the thermoelectric module 24. The differential in temperature between the module's surfaces causes the thermoelectric module to generate direct current which flows through wires 32. This current is sufficient to provide power to operate a small radio or other small electric appliance or device when connected to the wires.

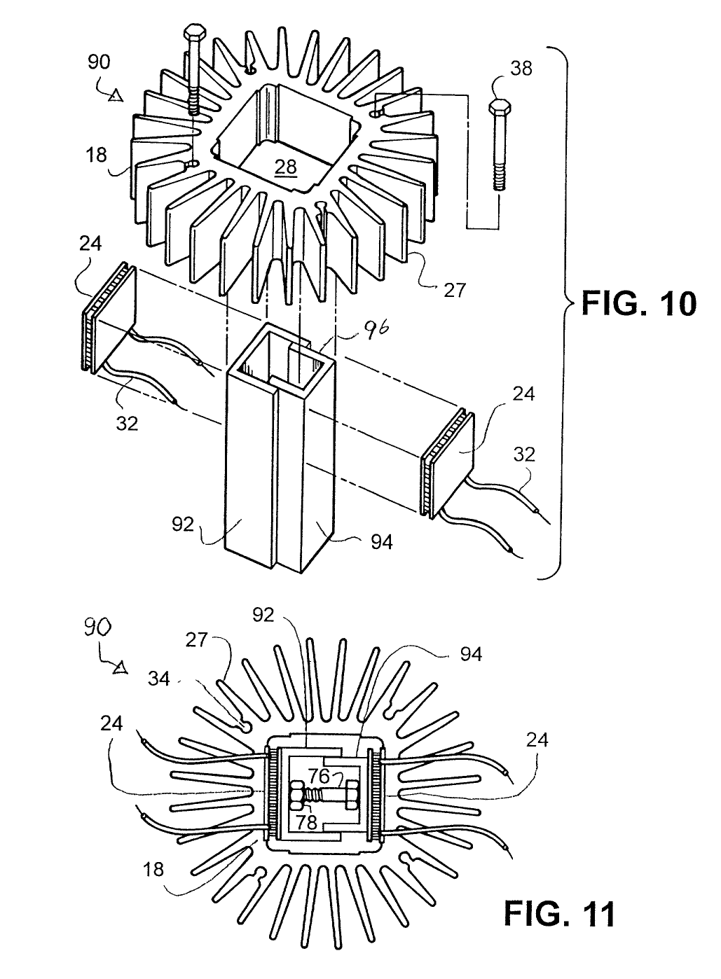

Referring to FIGS. 10 and 11, a third embodiment of a thermoelectric converter assembly, generally designated 90, is illustrated to be similar to the first embodiment of FIG. 1, the differences being: (1) a plurality of converter modules 24 (illustrated here to be two), (2) a two-piece, laterally expandable heat pipe, 92 and 94, (3) use of an expandable clamp, 76 and 78, inside the heat pipe rather than the set screws, and (4) one or more heat transfer plates (22 of FIG. 2) depending on whether additional spacing is needed to securely clamp the converter modules 24 to the inside walls of the heat sink 18, or for more efficient heat transfer. As illustrated, the expandable heat pipe includes two elongated members each having a U-shaped cross profile, the “U” of one 94 fitting snugly but slidably into the “U” of the other 92 to close the heat pipe except for its longitudinal ends, the outer size of the heat pipe being adjustable in a lateral direction. The pipe size adjustment depends on the size of a heat sink's cavity (e.g. 28) in which a heat egress end 96 of the pipe is disposed, the thickness of the modules, and any spacers used. Also, the modules can be connected in parallel for more current (but some additional circuitry is required such as diodes to prevent reverse current), or in series for additional voltage. Preferably the modules are coupled in either fashion and are further coupled to a power connector for quick connect/disconnect.

In operation it has been found that the thermoelectric modules, e.g. Model HT3-12-30 from Melcor, when used according to this invention produce about three to six volts DC depending on the current load, the amount of heat produced by the lantern. It has also been found that many DC devices, e.g. small portable radios, operate satisfactorily over that range.

The foregoing description and drawings were given for illustrative purposes only, it being understood that the invention is not limited to the embodiments disclosed, but is intended to embrace any and all alternatives, equivalents, modifications and rearrangements of elements falling within the scope of the invention as defined by the following claims. For example, the thermoelectric converter assemblies as described above can optionally include an inverter or other convention circuit for converting DC power to alternating current (AC) power for powering small AC appliances. As another example, opposite faces of the converter modules can be secured against a heat sink and against a heat pipe by means other than a clamp: an efficient heat transfer adhesive or bonding can be used to hold the assemblies together, or a heat pipe and one or more modules around it can be frictionally or force fitted within a through channel of a heat sink (or otherwise forced against respective walls of a heat sink), or the parts can be potted, i.e. encapsulated together in place by a heat conductive potting material. Also, the first embodiment (FIG. 1) can include an additional module with additional set screws engaged in the channel's wall opposite the additional module.

I claim:

1. A hand-transportable apparatus for generating electrical power comprising:
(a) a hand-transportable heat source,
(b) a thermoelectric converter including a first and second operative faces, the converter producing electrical power in response to a temperature differential between the two operative faces,
(c) a heat conduit for communicating heat from the heat source to the first operative face of the converter, and
(d) a heat dissipator for removing heat from the second operative face of the converter.

2. The apparatus according to claim 1 wherein the heat source is a hand-portable, fuel burning lantern.

3. The apparatus according to claim 2 further comprising a heat sink abutting the second operative face of the thermoelectric converter.

4. The apparatus according to claim 1 further comprising a heat pipe for communicating heat from the lantern to the first operative face of the thermoelectric converter.

5. The apparatus according to claim 3 further comprising a heat conductive bracket, upon which the heat sink is mounted, for communicating heat from the lantern to the first operative face of the thermoelectric converter.

6. The apparatus according to claim 1 wherein the lantern is a portable kerosene fueled lantern.

7. The apparatus according to claim 1 wherein the lantern is a portable propane fueled lantern.

8. The apparatus according to claim 1 further comprising a second thermoelectric converter including first and second operative faces.

9. The apparatus according to claim 8 wherein the heat source is a hand-portable, fuel burning lantern.

10. The apparatus according to claim 9 further comprising a heat sink abutting the second operative faces of the thermoelectric converters.

11. The apparatus according to claim 8 further comprising a heat pipe for communicating heat from the lantern to the first operative faces of the thermoelectric converters.

12. The apparatus according to claim 10 further comprising a heat conductive bracket, upon which the heat sink is mounted, for communicating heat from the lantern to the first operative faces of the thermoelectric converters.

13. The apparatus according to claim 8 wherein the lantern is a portable kerosene fueled lantern.

14. The apparatus according to claim 8 wherein the lantern is a portable propane fueled lantern.

15. A method of modifying a hand-transportable, heat producing lantern having a hood atop a shroud, to produce electrical power comprising the steps:
(a) removing the hood from the shroud; and
(b) mounting on the top of the shroud a thermoelectric converter assembly, the assembly comprising:
(1) a heat sink,
(2) a thermoelectric converter including first and second operative faces, the converter producing electrical power in response to a temperature differential between the two operative faces, the converter being disposed to communicate heat from the second operative face to the heat sink,
(3) a heat pipe projecting at one end into the shroud to receive heat therefrom, and at the other end abutting the first operative face of the converter, and
(4) a power outlet in electrical communication with an electrical output of the converter.

16. A method of modifying a hand-transportable, propane lantern having a top which is heated when the lantern is lit, to produce electrical power comprising the steps:
(a) affixing a heat conductive mounting bracket at the hottest point on the lantern top of the lantern; and
(b) affixing to the bracket a thermoelectric converter assembly, the assembly comprising:
(1) a heat sink,
(2) a thermoelectric converter including first and second operative faces, the converter producing electrical power in response to a temperature differential between the two operative faces, the converter being disposed to communicate heat from the second operative face to the heat sink,
(3) the bracket including a heat conductive interface, the interface being abutted to the first operative face of the converter, and
(4) a power outlet in electrical communication with an electrical output of the converter.
